(19) United States
(12) Patent Application Publication
(10) Pub. No.: US 2005/0273607 A1
(43) Pub. Date: Dec. 8, 2005

(54) User authentication system

(76) Inventors: Takeshi Yamana, Yokohama (JP); Kiyoto Takahashi, Yokohama (JP); Tatsuo Kondou, Yokohama (JP); Hideaki Okoshi, Yokohama (JP); Kazutoshi Kobayashi, Yokohama (JP)

Correspondence Address: KATTEN MUCHIN ROSENMAN LLP, 575 MADISON AVENUE, NEW YORK, NY, 10022-2585, US

(21) Appl. No.: 11/196,816

(22) Filed: Aug. 3, 2005

Related U.S. Application Data
(63) Continuation of application No. PCT/JP03/07509, filed on Jun. 12, 2003.

(51) Int. Cl. H04L 9/00

(52) U.S. Cl. 713/168; 713/182

(57) ABSTRACT

User information stored in a second server as a proxy authentification device is deleted from a first server performing authentification of the network connection. Accordingly, it is possible to easily and surely delete the user information stored in one of the plurality of second servers from the first server. That is, it is possible to delete user information stored in a server such as a proxy server acting for authentification in a short period of time.

### CROSS-REFERENCE TO RELATED APPLICATION

This is a continuation of Application PCT/JP2003/007509, filed on Jun. 12, 2003, now pending, the contents of which are herein wholly incorporated by reference.

### BACKGROUND OF THE INVENTION

1. Technical Field

The present invention relates to an authentication technology by which user authentication is conducted based on load sharing.

2. Background Arts

A network connection system using wireless LAN (Local Area Network) has hitherto been utilized. This type of system prepares a plurality of areas known as so-called hot spots where wireless LAN access points are provided. Then, a user operates a user terminal (connectable to the wireless LAN) at the hot spot, and can connect to a network (e.g., an IP (Internet Protocol) network) via the access point (AP).

The user authentication system for the network connection employing the wireless LAN has an authentication server for authenticating the user terminal (unillustrated) utilizing this network. The authentication server receives a user authentication request from the access point, then executes an authentication process, and sends a result of the authentication process back to the user via the access point.

On the occasion of connecting to the IP network, the user authentication is conducted by a network service provider such as an Internet service provider (ISP). In a procedure of this user authentication, a protocol for performing the user authentication involves using generally RADIUS (Remote Authentication Dial In User Service). The RADIUS is standardized as RFC2138/RFC2139 by IETF (Internet Engineering Task Force), and a source code of a RADIUS server is open to the public.

The user terminal connecting to the access point by employing a communication function of the wireless LAN etc. uses an authentication protocol such as the RADIUS and PAP (Password Authentication Protocol) or CHAP (Challenge Handshake Authentication Protocol) within PPP (Point to Point Protocol). In this case, the user terminal sends a RADIUS-based authentication request packet stored with user information (a user ID, a password, etc.) used for the authentication process to the access point by use of the protocol described above. The authentication request packet is transferred to the authentication server via the access point.

The authentication server executes the following process in the case of accepting the authentication request packet from the access point. At first, the authentication server executes the user authentication process on the basis of the accepted authentication request packet and the user information retained beforehand by the authentication server. Then, the authentication server transmits a response packet containing a result of the authentication process to the access point to which the user connects. The access point accepting this response packet, if the authentication result is “success (permission)”, deems that this user authentication gets successful (permitted), and therefore permits this user terminal to connect with the network.

In the user authentication system employing the RADIUS protocol, the authentication server is configured by a home server and one or more proxy servers in order to attain load sharing of the authentication server in some cases. The proxy server exists between the user terminal and the home server and relieves a load of the authentication process in the home server.

FIG. 13 is a diagram showing one example of a load sharing type user authentication system. FIG. 13 shows one example of the authentication process of the first time and the authentication processes from the second time onward in such a case that one unspecified user connects to the network via the same proxy server.

In FIG. 13, the authentication process of the first time in the connection to the network is executed as below. To start with, the proxy server receiving the authentication request packet containing the user information from the user terminal judges whether or not a self-possessed storage means (cache memory) is stored (cached) with the user information contained in the authentication request packet. Herein, the user information is not cached, and hence the proxy server transmits the authentication request packet to the home server. The home server, upon receiving the authentication request packet, executes the user authentication process on the basis of the user information contained in this packet and the user information that is previously retained by the home server itself and required for the authentication process. The home server, if this authentication request packet is normal (if the authentication gets successful), transmits a response packet containing information representing the success in authentication (the connection permitted) and the user information to the proxy server. The proxy server, after storing (caching) the storage means (cache memory) with the user information contained in the response packet, transmits the response packet to the user terminal via the access point. In the authentication processes from the second time onward, the proxy server, when receiving the user authentication request packet from the user terminal, judges in the same way as the first time whether or not the user information associated with the authentication request packet is cached on the cache memory. Herein, the user information is cached, and therefore the proxy server executes the authentication process as a substitute for the home server by use of the user information, generates a response packet showing “permission” and sends this packet to the user.

The user authentication system for the network connection described above is thus configured, whereby, for instance, when the user is once authenticated, the user authentication is carried out by using the user information stored on the cache memory of the proxy server from the authentication of the next time. Accordingly, in the user authentication system for the network connection, the load of the home server is shared with the proxy server. Then, the cache of the proxy server is stored with the user information of the individual user.

FIG. 14 is a diagram showing one example of a problem arising when deleting the user information in the load sharing type user authentication system described above. The user information managed by the home server is deleted or changed due to expiration of a contract between the user and the network service provider or by changing a password and so on. As shown in FIG. 14, even in the case of deleting or changing the user information of a certain user on the home server, there is a state where the user information related to the deletion or the change remains on the cache memory of the proxy server. Namely, there is kept such a state that the user information deleted or changed in the home server remains stored on the cache memory of the proxy server unless the delete process is executed. Therefore, the user information of a certain user is deleted or changed in the home server, and nevertheless there is a possibility in which the network connection using the user information related to the deletion or the change might be permitted by the user information stored in the proxy server.

In the user authentication system described above, a method considered as a method of deleting the user information stored in the proxy server is that the user information stored in the proxy server is deleted periodically (at an interval of a predetermined period such as once a day) by an administrator's operating the proxy server.

The method described above, however, presents the following problems. The cache-clear method conducted at the interval of the predetermined period requires deleting the delete target user information by checking whether or not the delete target user information is left on the cache memory in a way that individually operates all the proxy servers. Therefore, a considerable period of time might be expended till the cache-clear is performed after deleting or changing the user information in the home server. During this period, the network connection might be permitted by the old user information related to the deletion or the change.

It is to be noted that a technology (refer to, e.g., Patent document 1) of blocking connections of other computers by encrypting the user information, a technology (refer to, e.g., Patent document 2) of deleting registration from the proxy server and a technology (refer to, e.g., Patent document 3) related to a communication device, are disclosed as technologies related to the management of the user information for the network connection.

Patent Document 1
Japanese Patent Application Laid-Open Publication No. 2001-312466

Patent Document 2
Japanese Patent Application Laid-Open Publication No. 2001-224070

Patent Document 3
Japanese Patent Application Laid-Open Publication No. 11-24950

### SUMMARY OF THE INVENTION

It is an object of the present invention, which was devised in view of the points described above, to provide a technology capable of deleting user information stored on a server such as a proxy server that substitutionally executes an authentication process in a short period of time.

The present invention adopts the following means in order to solve the problems described above.

A user authentication system according to the present invention comprises a first server executing a user authentication process and a transmission process of an authentication result when receiving a request for authenticating a user's access to a network. Further, the user authentication system according to the present invention comprises at least one second server existing between the user and the first server, having a storage unit, executing the authentication process and notifying the user of the authentication result thereof as a substitute for the first server by use of, if the storage unit is stored with user information for authenticating the user when receiving the authentication request from the user, this user information, transferring the authentication request to the first server if the storage unit is not stored with the user information concerned, receiving from the first server the authentication result about the authentication request and notifying the user of this authentication result, and storing, if the notified authentication result indicates a success of authentication at this time, the storage unit with the user information of the user concerned that is contained in the authentication result. Then, the first server includes a unit transmitting a user information delete request to the second server of which the storage unit is stored with the user information. Moreover, at least the one second server includes a unit deleting, when receiving the delete request from the first server, the user information specified by this delete request from the storage unit.

According to the present invention, the user information stored on the second server substitutionally executing the authentication process is deleted from the first server executing the authentication process for the network connection. Hence, according to the present invention, the user information stored on any one of the plurality of second servers can be subjected to the process of being easily surely deleted from the first server. Namely, according to the present invention, it is possible to delete the user information stored on the server such as a proxy server that substitutionally executes the authentication process in a short period of time.

Further, according to the present invention, the first server may further include a unit inferring, when receiving an instruction of deleting specified user information, the second server of which the storage unit is stored with this specified user information, and a unit generating a delete request of the specified user information that is sent to the inferred second server.

Moreover, according to the present invention, the first server may further includes a unit retaining history information of the authentication process with respect to the user, and a unit inferring, from the history information, the second server stored with delete target user information.

Hence, according to the present invention, the specified user information stored on the second server can be easily surely deleted from the first server.

Still further, according to the present invention, the first server may further include a unit storing a storage unit with the authentication request received from the second server, and a unit inferring, from the authentication request stored on the storage unit, the second server stored with the delete target user information.

Therefore, according to the present invention, the second server to be a delete request (transmission) target server can be easily determined.

Yet further, according to the present invention, the first server further includes a unit inferring, when receiving an instruction of deleting all the user information, all of the second servers of which the storage unit are stored with the user information, and a unit generating a delete request, to be sent to the inferred second servers, for deleting all the user information stored on the storage unit.

Hence, according to the present invention, the second server to be the delete request (transmission) target server can be easily determined.

Moreover, according to the present invention, the second server may include a Web server receiving a HTTP message sent from the first server and containing the delete request, and a CGI started up by the Web server and executing a process of deleting the user information designated by the delete request from the storage unit.

Therefore, according to the present invention, the process of deleting the user information stored on the server such as the proxy server that substitutionally executes the authentication process in the short period of time, can be easily actualized in a way that applies a Web system configured by a Web client and a delete request generation CGI provided in the first server and by a Web server and a delete processing CGI provided in the second server.

Furthermore, according to the present invention, each of the first server and the second server may receive a RADIUS-based authentication request packet and executes the authentication process, the first server may transmit the authentication request packet containing the user information delete request to the second server of which the storage unit is stored with the delete target user information, and the second server may delete, if the received authentication request packet contains the user information delete request, the user information designated by this delete request from the storage unit.

Hence, according to the present invention, the user information delete request can be transmitted from the first server without providing a new port for deleting the user information.

Further, the present invention may be a program for actualizing any one of the functions described above. Furthermore, the present invention may also be a readable-by-computer storage medium stored with such a program.

### BRIEF DESCRIPTION OF THE DRAWINGS

FIG. 1 is a schematic configuration diagram illustrating respective components of a user authentication system according to the present embodiment;

FIG. 2 is an explanatory diagram of a user information delete processing procedure employing HTTP in the user authentication system according to the present embodiment;

FIG. 3 is an explanatory diagram of the user information delete processing procedure using RADIUS in the user authentication system;

FIG. 4A is a diagram showing one example of a configuration along a first method of a proxy server specifying unit shown in FIG. 1;

FIG. 4B is a schematic diagram showing one example of the user authentication system to which the proxy server specifying unit shown in FIG. 4A is applied;

FIG. 5 shows one example of an authentication packet;

FIG. 6 is an explanatory flowchart of a procedure for determining a delete request transmitting destination proxy server by referring to a log;

FIG. 7 is a diagram showing one example of one record structuring the log;

FIG. 8 is a diagram showing one example of a RADIUS attribute format;

FIG. 9A is a diagram showing an example of a configuration along a second method of the proxy server specifying unit shown in FIG. 1;

FIG. 9B is a schematic diagram showing one example of the user authentication system according to the second method;

FIG. 10 is an explanatory flowchart of a delete request transmission target proxy server determining procedure based on packet queuing;

FIG. 11 is an explanatory flowchart of a user information delete processing procedure with a user ID designated;

FIG. 12 is an explanatory flowchart of a process of deleting caches cached with user information of all the users, which are provided on the side of the proxy servers from the home server;

FIG. 13 is a diagram showing one example of a load sharing type user authentication system; and

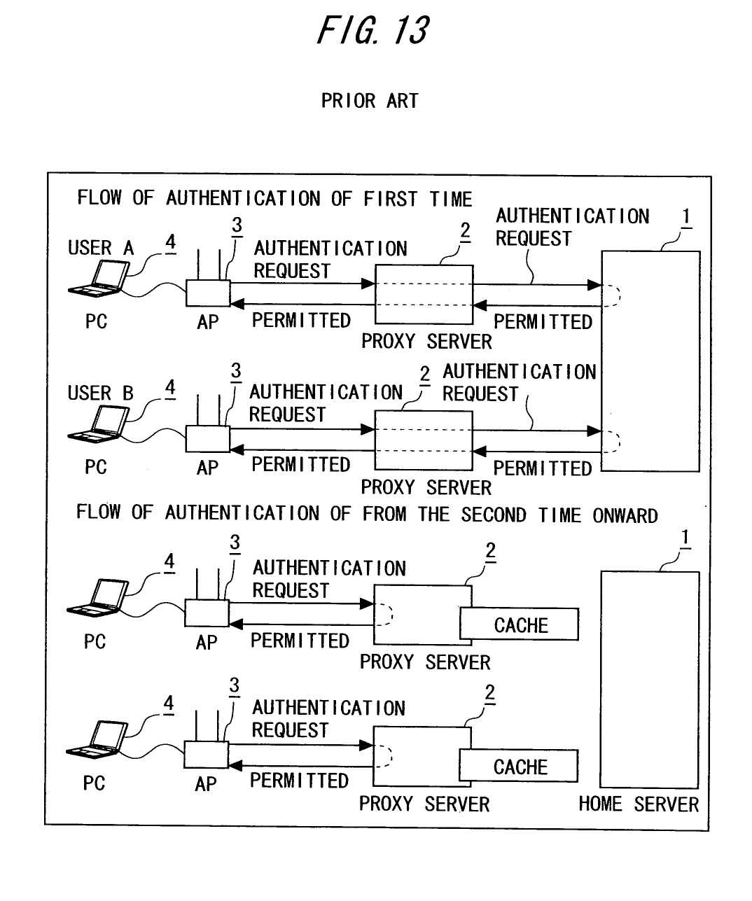

FIG. 14 is a diagram showing one example of a problem arising when deleting the user information in the load sharing type user authentication system as described above.

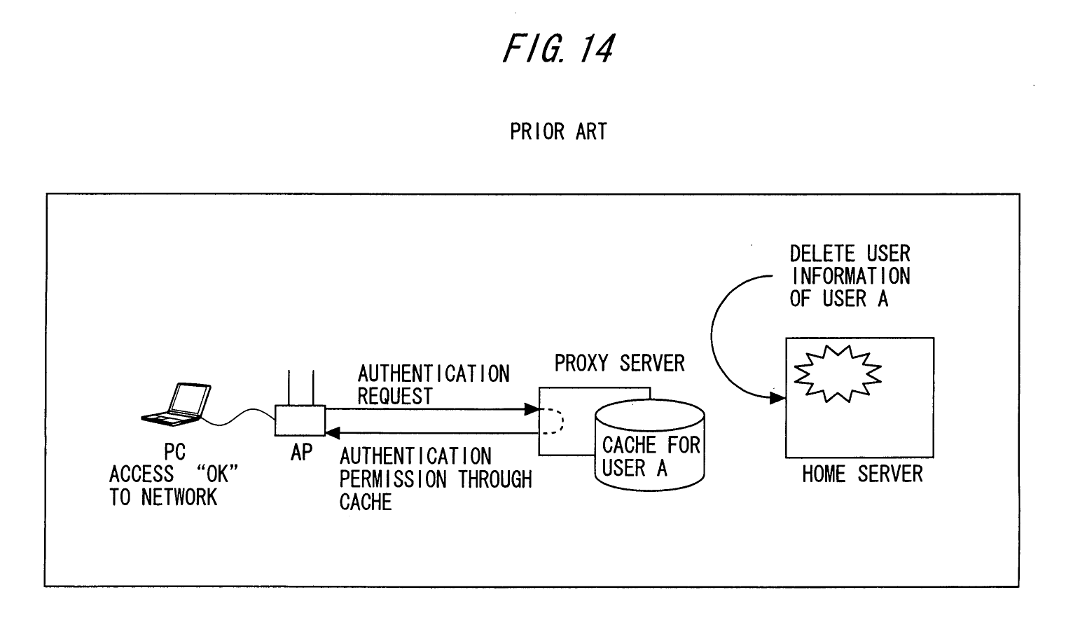

### DETAILED DESCRIPTION OF THE INVENTION

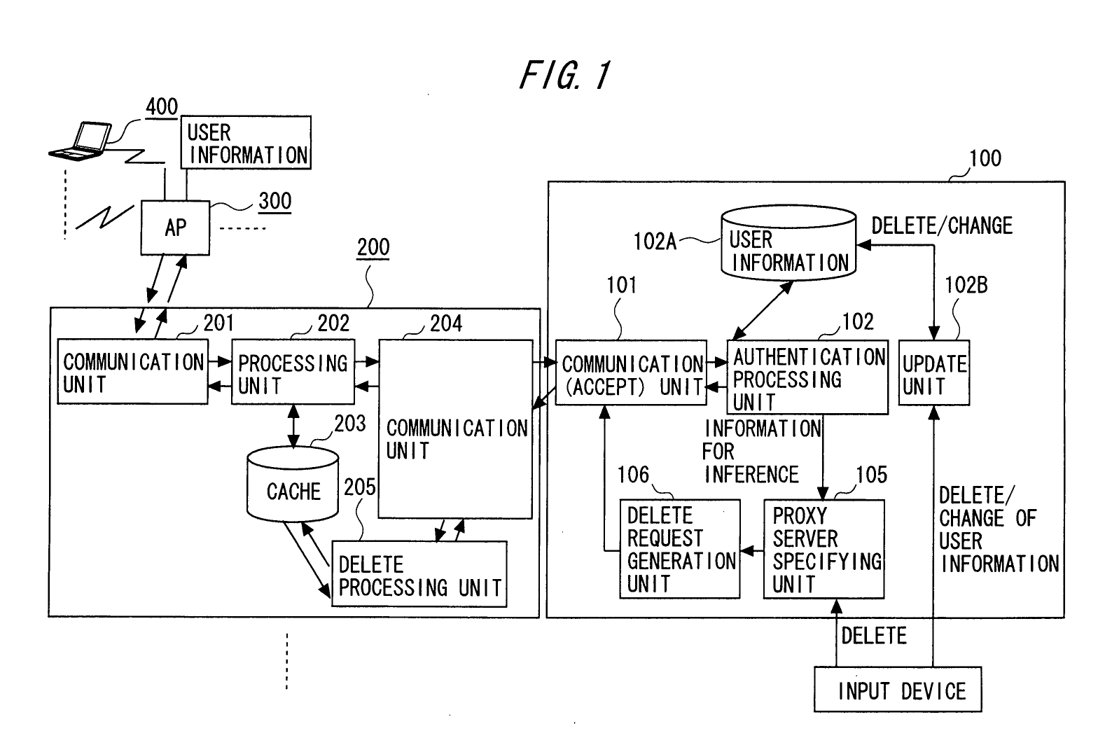

A user authentication system according to a preferred embodiment of the present invention will hereinafter be described with reference to the drawing in FIG. 1 through 12.

<System Architecture>

FIG. 1 is a schematic configuration diagram illustrating respective components of the user authentication system according to the present embodiment.

FIG. 1 shows an example of the components of the user authentication system in a case where a user connects to (accesses) an IP network via an access point disposed at a hot spot etc. by operating a wireless LAN terminal.

The user authentication system includes a home server 100 and a proxy server 200, and the proxy server 200 exists between the home server 100 and a user (a user terminal 400) and is connected to an access point (AP) 300 via a network. The terminal 400 is connectable to the access point 300 via a wireless LAN. Note that FIG. 1 illustrates only one proxy server 200, however, a plurality of proxy servers 200 are prepared according to the necessity. Further, a plurality of access points 300 are likewise prepared according to the number of hot spots etc.

<Configuration of Homer Server>

Next, components of the home server 100 according to the present embodiment will be explained. The home server 100, when receiving a user's authentication request for accessing the network, executes this user authentication process and a process of transmitting an authentication result. Further, the home server 100 generates a request for deleting user information according to the present invention, and sends this delete request to the proxy server 200.

The home server 100 is constructed by use of a computer such as a personal computer (PC), a workstation (WS) and a dedicated server machine. The home server 100 includes, unillustrated pieces of hardware, a control device (constructed of a CPU, a main storage(main memory) (a RAM etc), an Input/Output unit, a device driver, etc.), a secondary storage (a hard disc etc.), a communication control device (a network interface device etc.), an input device (a keyboard, a mouse, etc.), and an output device (a display device etc.). Then, the CPU loads a program stored on the secondary storage and then executes the program, whereby the home server 100 functions as a device that actualizes the functions as shown in FIG. 1.

To be specific, the home server 100 functions as the apparatus including a communication (accepting) unit 101, an authentication processing unit 102, a proxy server specifying unit 105 and a delete request generation unit 106. It is to be noted that the home server 100 corresponds to a first server of the present invention.

The communication unit 101 controls the communications with the proxy server etc. For instance, the communication unit 101 receives the user's authentication request for accessing the network from the proxy server 200. Further, the communication unit 101 executes the process of transmitting the authentication result in response to the normal authentication request. Moreover, the communication unit 101 sends the delete request of the proxy server 200.

The authentication processing unit 102 receives the authentication request received by the communication unit 101, and executes the authentication process in response to this authentication request. The authentication processing unit 102 is linked to a database 102A (structured on, e.g., the secondary storage) stored with all records of user information, and executes the authentication process by judging whether or not the user information contained in the authentication request is registered on the database 102A. At this time, the authentication result gains a success if the database 102A contains the user information concerned but gets into a failure whereas if not.

The database 102A is linked to an update unit 102B. The update unit 102B deletes a delete target record of user information from the database 102A in accordance with a user information delete/change instruction inputted from the input device, and changes (updates) a change target record of user information.

The proxy server specifying unit 105 specifies the proxy server 200 stored with the delete target user information from the plurality of proxy servers 200. The proxy server specifying unit 105 receives pieces of information (such as an authentication request packet and the authentication result) for inferring the proxy server from the authentication processing unit 102, and manages this inference information. Further, the proxy server determination unit 105 specifies (infers) one or more proxy servers that should be given the delete request by use of the inference information in accordance with the user information delete/change instruction inputted from the input device. It should be noted that the delete instruction includes a case of deleting the user information from the database 102A and from a cache memory 203 and also a case of deleting the user information from only the cache memory 203.

The delete request generation unit 106 generates the delete request of the user information stored on the cache memory 203 of the proxy server 200 with respect to a specifying result (the proxy server to which the delete request should be sent) of the delete request which the proxy server specifying unit 105 notifies of. The delete request contains information for specifying (inferring) the delete target user information. This specifying information can contain the delete target user information or a designation of deleting all the records of user information on the cache memory 203. Note that the delete request generation unit 106 corresponds to a unit for generating the delete request according to the present invention.

<Configuration of Proxy Server>

Next, the proxy server 200 according to the present embodiment will be explained. The proxy server 200 according to the present embodiment exists between the terminal on the user side and the home server 100. The proxy server 200 can be constructed, as in the case of the home server 100, by employing the PC, the WS, or the dedicated server machine, which includes the control device, the secondary storage, the communication control device, the input device, the output device, etc., and the CPU configuring the control device executes the program on the secondary storage, whereby the proxy server 200 functions as the device actualizing the functions as shown in FIG. 1.

Namely, the proxy server 200 functions as the apparatus including an access-point-side communication unit 201 that controls a process of receiving the authentication request from the access point 300 and a process of sending a response to the authentication request to the access point 300, an authentication processing unit 202 that executes the authentication process in response to the authentication request accepted by the communication unit 201, a cache memory (a storage unit) 203 for storing the user information used in the case where the authentication processing unit 202 executes the authentication process, a home-server-side communication unit 204 that controls a process of transferring the authentication request to the home server 100 and a process of receiving the response to the authentication request from the home server 100 and receiving the delete request therefrom, and a delete processing unit 205 that deletes, from the cache memory 203, the user information designated by the delete request accepted by the communication unit 204.

The authentication processing unit 202, upon receiving the authentication request, judges whether or not the cache memory 203 is stored with the same user information as the user information contained in this request, thus executing the authentication process responding to the authentication request. At this time, the authentication processing unit 203 transfers the authentication request to the communication unit 204 if the concerned record of user information is not stored therein, and generates and transfers a response to the authentication request containing information indicating “success (permission)” as a authentication result to the communication unit 201 if stored therein.

Further, the cache memory stores (caches) the user information received by the communication unit 204 and contained in the response that contains the information indicating the “success” given from the home server 100. This user information storage process can be executed by, for example, the authentication processing unit 202. It should be noted that the proxy server 200 corresponds to a second server of the present invention.

<Configuration of Access Point>

The access point 300 is a wireless LAN connecting point that accepts a user's request for accessing the network from the user-side terminal 400 etc. The access point 300 receives the authentication request information and the user information from the user such as a user ID, an authentication password, or source address information as a packet.

<Configuration of Terminal>

The terminal 400 is a general type of information processing apparatus such as a PC and a PDA (Personal Digital Assistant/Personal Data Assistant) each having a wireless LAN connecting function. This terminal 400 connects to the access point 300 by use of the wireless LAN connecting function. Then, the terminal 400 connects to the network via this access point 300.

<User Information Delete Procedure Using HTTP>

Next, in the user authentication system according to the present embodiment, a user information delete processing procedure using HTTP (HyperText Transfer Protocol) will be described.

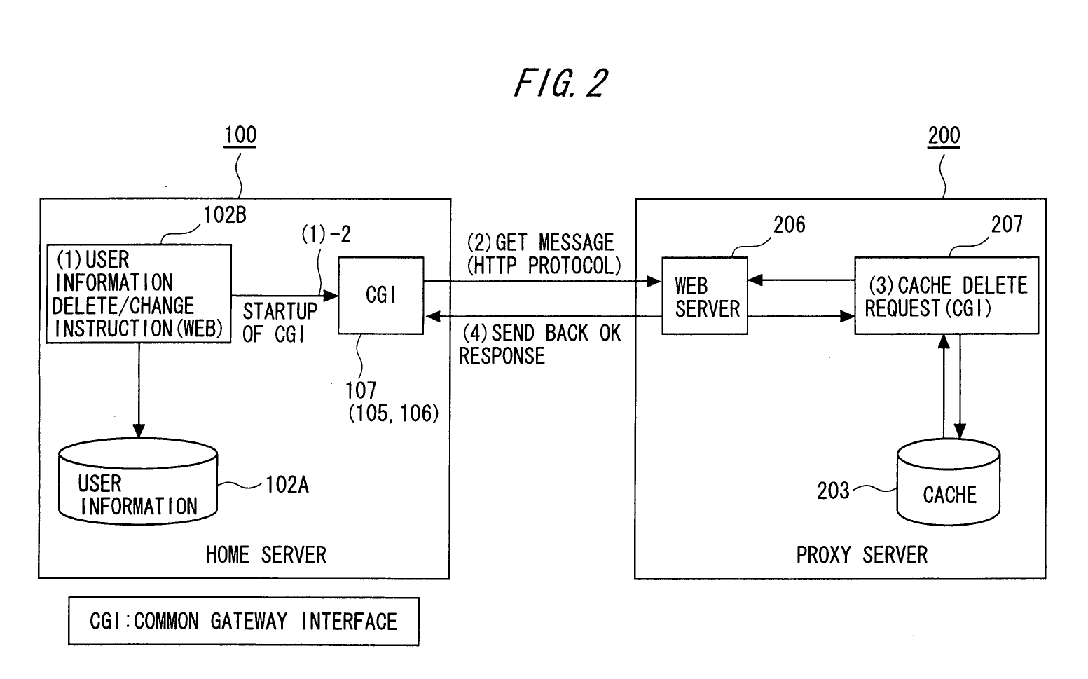

FIG. 2 is an explanatory diagram of the user information delete processing procedure employing the HTTP in the user authentication system according to the present embodiment. In FIG. 2, the home server 100 is configured to function as a Web client. Specifically, the home server 100 is configured to provide an administrator with a user interface (maintenance screen) based on a Web browser screen (unillustrated) on which to perform the deleting/changing operation of the user information, wherein when a user information deleting/changing instruction is inputted via this screen, an update unit 102B deletes or changes the user information within the database 102A. Moreover, the home server 100 is configured to issue, as the user information deleting/changing instruction is inputted, a startup command to a CGI (Common Gateway Interface) 107 for actualizing functions as the proxy server specifying unit 105 and the delete request generation unit 106 shown in FIG. 1.

On the other hand, in FIG. 2, the proxy server 200 is configured so as to include a Web server 206 containing the function as the communication unit 204 illustrated in FIG. 1 and a CGI 207 for actualizing the function as the delete processing unit 205. From on the maintenance screen displayed on the display (not shown) provided in the home server 100, an operator conducts the user information changing process such as deleting the user information or changing the password etc. while referring to the maintenance screen of the home server 100 (\mathring{1} in FIG. 2). At this time, the user information deleting/changing instruction is inputted to the home server 100. Then, the update unit 102B deletes or changes the concerned record of user information from or in the database 102A. On the other hand, the startup command is issued to the CGI 107 (\mathring{1}-2 in FIG. 2).

The CGI 107 infers, corresponding to the execution of the user information changing process, the target proxy server 200 to which the user information delete request is to be given. Then, the proxy server specifying unit 105 generates, as a delete request, an HTTP-based GET message addressed to the inferred proxy server 200. The GET message contains the information for specifying the delete target user information and the startup request, to be given to the inferred proxy server 200, of the CGI that executes deleting the user information. Then, the CGI 107 sends this GET message to the proxy server 200 (\mathring{2} in FIG. 2).

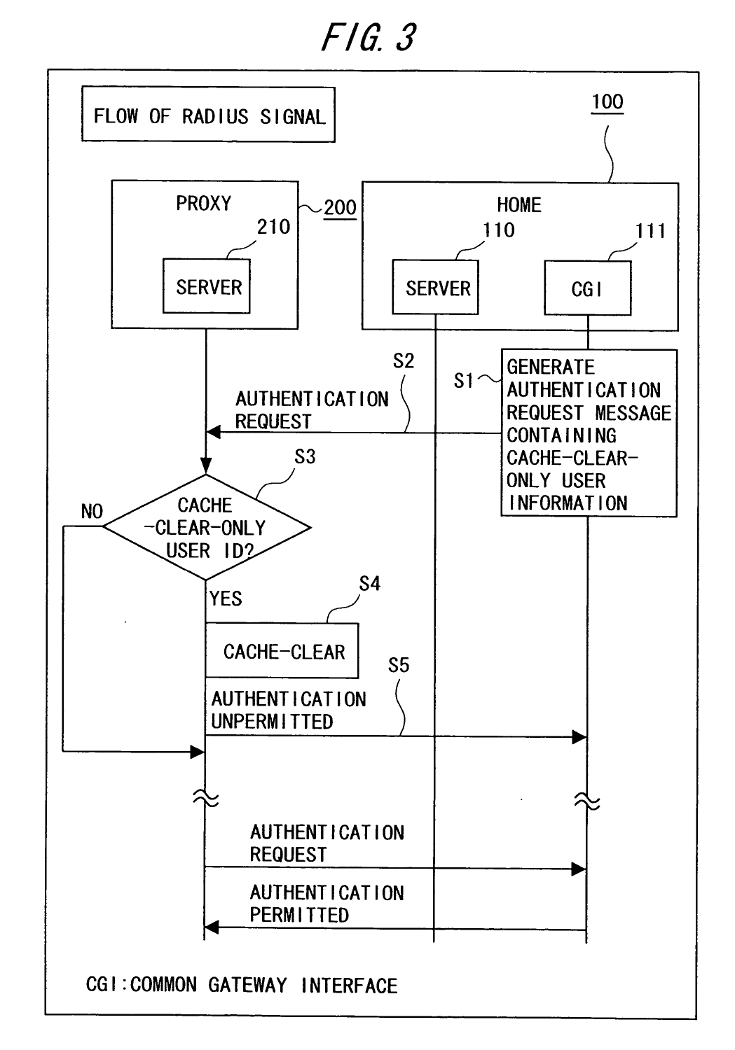

The Web server 206 of the proxy server 200, when receiving the GET message as the delete request, starts up the CGI 207 that executes a cache clear process of the user information in response to the CGI startup request contained in this GET message. The CGI 207 deletes the concerned record of user information from the cache memory 203 (\mathring{3} in FIG. 3) on the basis of specifying information (designation information) in the user information contained in the GET message.

Thereafter, the Web server 206 receives a completion notification of the user information deleting process from the CGI 207. Then, the Web server 206 generates an OK response message representing the completion of the deleting process, and sends this message back to the home server 100 (\mathring{4} in FIG. 2).

Thus, the user information deleting process according to the present invention can be easily actualized by applying the Web system configured by the Web client and the CGI for generating the delete request that are provided in the home server 100 and by the Web server and the CGI for the deleting process that are provided in the proxy server 200.

<User Information Delete Processing Procedure Using RADIUS>

Given next is an explanation about a user information delete processing procedure using RADIUS (Remote Authentication Dial In User Service) in the user authentication system.

FIG. 3 is an explanatory diagram of the user information delete processing procedure using the RADIUS in the user authentication system. As shown in FIG. 3, the home server 100 and the proxy server 200 are provided respectively with RADIUS servers 110, 210 that execute the RADIUS-based authentication process. The RADIUS servers 110, 210 correspond respectively to the authentication processing units 102, 202 shown in FIG. 1. Further, a CGI 111 having functions as the proxy server specifying unit 105 and as the delete request generation unit 106 shown in FIG. 1, is prepared in the home server 100.

When the user information deleting/changing instruction is given to the home server 100, the updating unit 102B updates the database 102A. Moreover, a startup request is given to the CGI 111. Then, the CGI 111 infers the target proxy server 200 to which the user information delete request is given. Then, the proxy server specifying unit 105 generates the delete request addressed to the inferred proxy server 200. Herein, the CGI 111 creates a RADIUS-based authentication request message (S1). This authentication request message contains fields stored with items of authentication target user information. The CGI 111 stores one of the fields with a piece of information only for clearing the cache as information for specifying the delete target user information. The cache-clear-only user information has a format distinguishable to the RADIUS server 210 of the proxy server 200. For instance, in the RADIUS, the user information is generated in the form of “user ID/password” that is a combination of a user ID (user name: User-Name) and a password (User-Password). A special character string representing “cache clear” (the deletion of the user information) is applied to the user ID at this time, whereby the user information gets distinguishable. The cache-clear-only user information can specify one record of delete target user information or all the records of user information within the cache 203. Then, the CGI 111 sends the authentication request message to the proxy server 200 in accordance with a RADIUS protocol (S2).

The RADIUS server 210 of the proxy server 200 judges whether or not the received authentication request message contains the cache-clear-only user information (S3). At this time, if the cache-clear-only user information is contained, the RADIUS server 210 judges that this authentication request is the user information delete request (S3: YES). In this case, the RADIUS server 210 deletes, from the cache memory 203 (cache clear), a record of user information that can be specified from the cache-clear-only user information (S4).

After executing the cache clear process, the RADIUS server 210 sends non-permission of authentication (failure in authentication) as a response to the authentication request back to the home server 100 (S5). The following is a reason why the proxy server 200 sends the non-permission of authentication to the home server 100. Namely, supposing that the proxy server 200 is configured to send back a response showing the authentication permission in response to the authentication request containing the cache-clear-only user information, a third party who acquired the cache-clear-only user information is prevented from unlawfully intruding in the network by abusing this user information.

Note that if the user information contained in the authentication request given from the home server 100 is not the cache-clear-only user information (S3; NO), the RADIUS server 210 is configured not to execute the processing in particular. For example, if the user information contained in the authentication request message is not the cache-clear-only user information and if a source (sender) of the authentication request message is the home server 100, the RADIUS server 200 can be configured not to execute the processing in particular.

When the proxy server 200 receives the authentication request from the concerned user after the delete target user information has been deleted from the cache memory 203, this authentication request is transferred to the home server 100 from the proxy server 200. Then, as for this authentication request, the authentication process for the network connection is conducted by use of the already-changed user information in the home server 100.

According to a RADIUS-protocol-based method of transferring the delete request to the proxy server 200 from the home server 100, by utilizing the RADIUS protocol, the home server 100 as a RADIUS client generates an authentication request message (delete request) containing the cache-clear-only user information, and sends the delete request to the proxy server 200 in a way that employs a RADIUS authentication procedure using a for-the-RADIUS TCP/IP port that is set beforehand between the proxy server 200 and the home server 100. Accordingly, the home server 100 can send the delete request to the proxy server 200 from the home server 100 itself without using a new TCP/IP port only for cache-clear. This scheme eliminates a necessity of changing re-setting (filtering condition) of a firewall so that the cache-clear-only TCP/IP port is not filtered by the firewall in a case where the home server 100 and the proxy server 200 are separated by the firewall.

Thus, the home server 100 is provided with the CGI 111 for generating and sending the authentication request message (delete request) containing the cache-clear-only user information, and the RADIUS server 210 of the proxy server 200 is provided with a routine for executing steps S3 through S5 is added to, thereby making it possible to delete a desired (want-to-delete) record of user information stored on the cache memory 203 of the proxy server 200.

<Procedure of Determining Proxy Server for Sending Delete Request by Referring to History Information>

Given next is a description of a procedure (a configuration of the proxy server specifying unit 105) for determining the proxy server as a destination to which the user information delete request is transmitted in the user information delete process as a first proxy server specifying method.

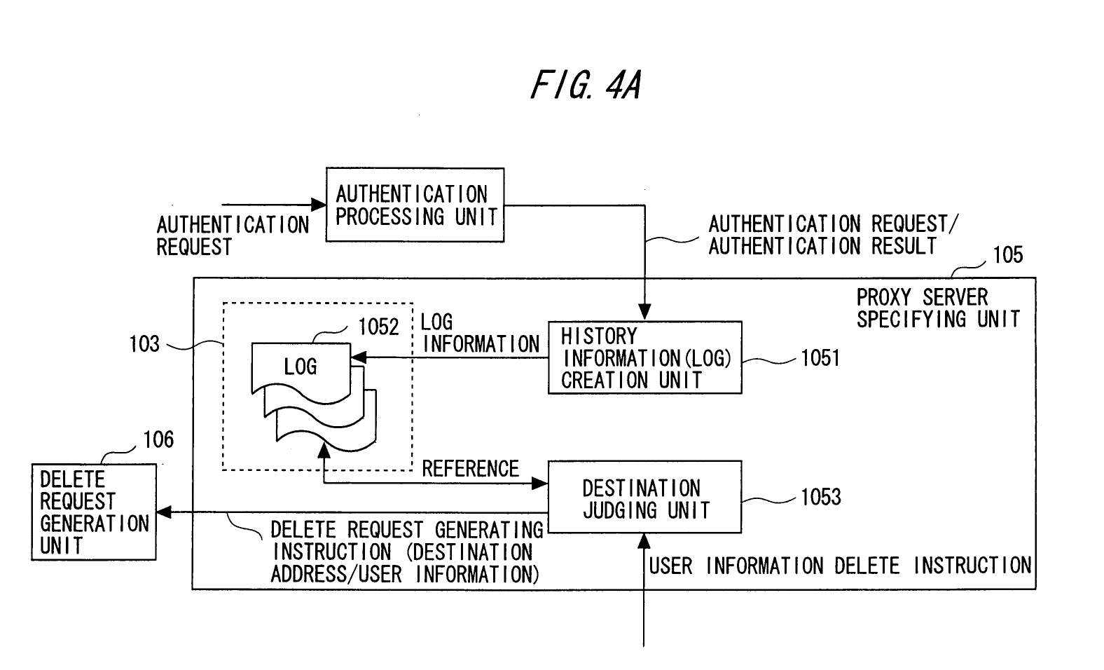

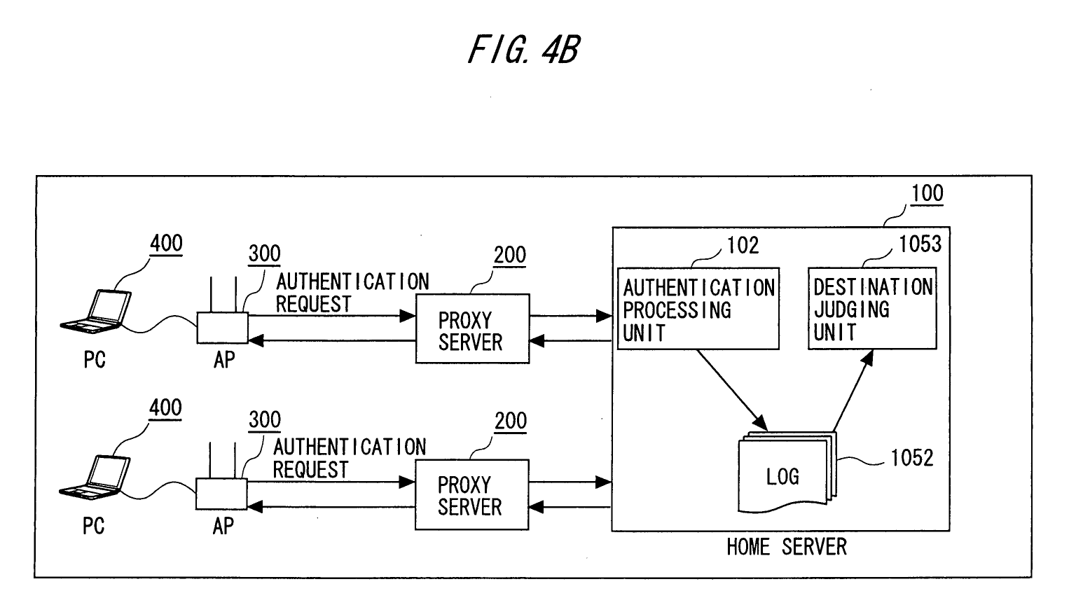

FIG. 4A is a diagram showing one example of a configuration along the first method of the proxy server specifying unit 105 shown in FIG. 1, and FIG. 4B is a schematic diagram showing one example of the user authentication system to which the proxy server specifying unit 105 shown in FIG. 4A is applied.

In FIG. 4A, the proxy server specifying unit 105 includes a history information (log) creating unit 1051, history information (log) 1052 and a destination judging unit 1053. The history information creating unit 1051 receives an authentication request and an authentication result (information for inference) responding this request, then creates a record containing a content of the authentication request related to each authentication process and a result thereof, and stores this record in a predetermined storage area (a history information storage unit 103).

The history information (log) 1052 is an aggregation of records created by the history information creating unit 1051.

The destination judging unit 1053 infers the proxy server 200, of which the cache memory 203 is stored with the delete target user information, by referring to the history information 1052 in response to the user information delete instruction, and gives the information related to the inferred proxy server 200 as destination information to the delete request generation unit 106.

FIG. 4B illustrates the home server 100 having the proxy server specifying unit 105 shown in FIG. 4A, at least one proxy server 200, the access points (which will hereinafter also be abbreviated to “APs”) 300 and network-connectable terminals (PCs) 400 utilized by users.

In the user authentication system shown in FIG. 4B, the authentication method of the user information stored as a cache within the proxy server 200 involves, it is desirable, applying, for instance, authentication using a MAC (Media Access Control) address, or authentication based on a PAP(Password Authentication Protocol) method. Herein, an example where the PAP-based authentication method is applied will be explained.

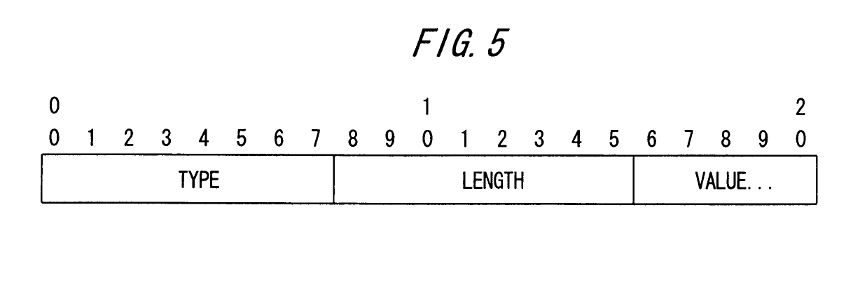

As described above, the history information creating unit 1051 of the home server 100 creates, on the history information storage unit 103, the history information (log) 1052 of the authentication process for each record of user information, which has been executed by the authentication processing unit 102. Then, the destination judging unit 1053 of the home server 100 executes, based on this log 1052, a process of determining the proxy server 200 corresponding to the destination to which the delete request is transmitted. FIG. 5 shows one example of an authentication request packet.

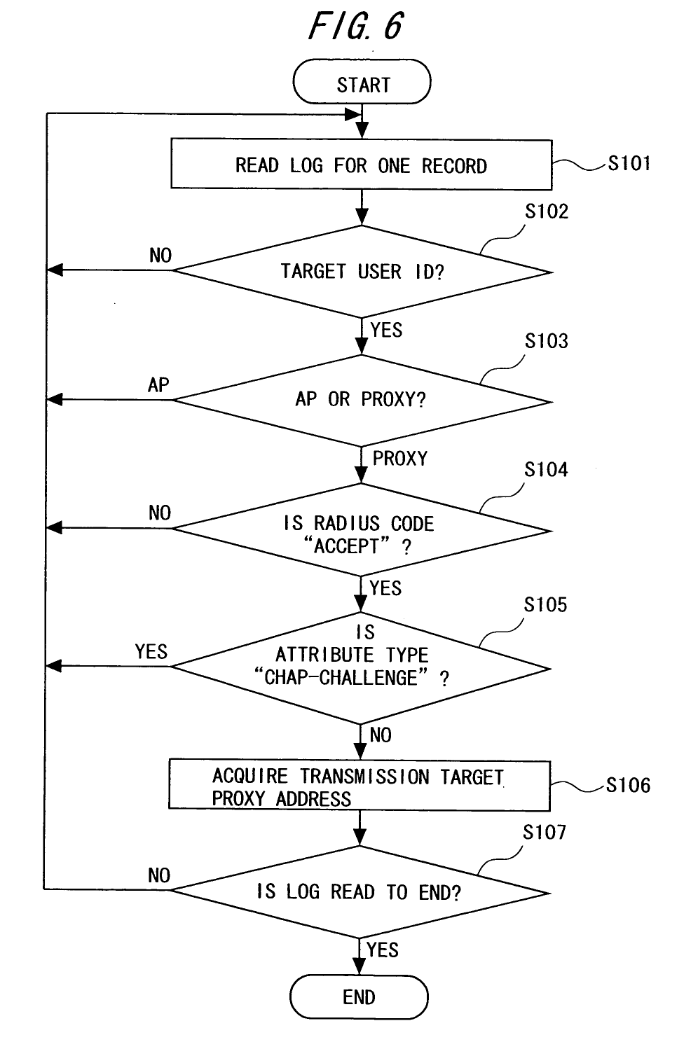

FIG. 6 is an explanatory flowchart of the procedure (a process of the destination judging unit 1053) for determining the proxy server as the destination of the delete request packet by referring to the log 1052. This process is started when, for example, the destination judging unit 1053 receives the user information delete instruction inputted by the operator.

The destination judging unit 1053, upon starting the process, reads one record of the log 1052 stored on the history information storage unit 103 (step 101, which will hereinafter be abbreviated such as “S101”).

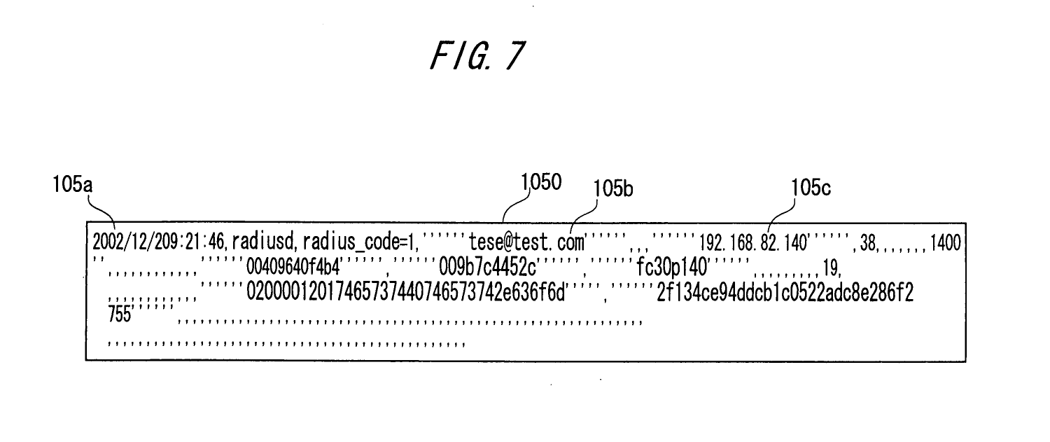

FIG. 7 is a diagram showing one example of one record 1050 structuring the log 1052 read in S101. Recorded in the record 105 are a connection date (authentication request reception date) 105a, a user ID 105b described in the form of “user ID (User-Name)/domain name”, RADIUS attribute information representing the authentication method, an authentication request packet source address 105c, etc.

The destination judging unit 1053 judges whether the user ID (the user information 105b) contained in the record 1050 corresponds to the delete target or not (S102). At this time, the processing returns to S101 if the user ID does not corresponds to the delete target (S102; NO), but advances to S103 whereas if the user ID corresponds thereto (S102; YES).

In S103, the destination judging unit 1053 judges, by referring to the source address 105c in the record 1050, whether the authentication request source is the proxy server 200 or not. The destination judging unit 1053 previously knows respective addresses of the AP 300 and the proxy server 200. At this time, if the source (sender) is the AP 300 (S103; AP), the processing returns to S101. By contrast, if the source (sender) is the proxy server 200 (S103; Proxy), the processing advances to S104.

If the authentication request source is judged to be the proxy server 200 (S103; Proxy), the destination judging unit 1053 judges whether or not RADIUS Code in the record 1050 is a code “accept” showing that the result of this authentication request is “success (permission)” (S104).

At this time, if RADIUS Code is “accept” (S104: YES), the destination judging unit 1053 executes a process in S105. Whereas if RADIUS Code is not “accept” (S104: NO), the processing returns to S101. Herein, the reason why the processing returns to S101 is that if the authentication gets into a failure (non-permission), the cache memory 203 of the proxy server 200 is not stored with the user information concerned.

In S105, the destination judging unit 1053 judges whether or not Attribute type contained as a piece of attribute information in the record 1050 is “CHAP-Challenge”. Namely, the destination judging unit 1053 judges whether or not the authentication method designated by the authentication request is a CHAP (Challenge Handshake Authentication Protocol) method.

At this time, if Attribute type is “CHAP-Challenge” (if the authentication method is CHAP: S105; YES), the destination judging unit 1053 returns the processing to S101. Herein, the reason why the processing is returned to S101 is that CHAP does not come under the authentication method carried out by the proxy server 200, and hence the user information in a format used in CHAP is not stored (cached) on the cache memory 203.

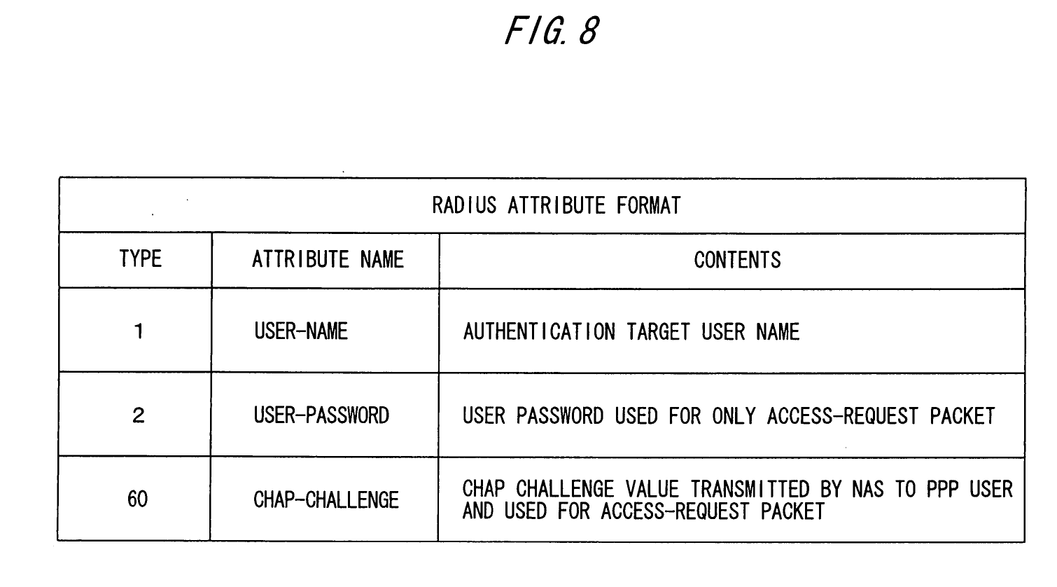

FIG. 8 is a diagram showing one example of a format of the RADIUS attribute. As shown in FIG. 8, when the authentication method is CHAP, a value “60” indicating “CHAP-Challenge” is set as Attribute type in the authentication request. The destination judging unit 1053 executes the process in S105 in a way that judges whether the value of Attribute type is “60” or not.

While on the other hand, in the process in S105, when Attribute type is not “CHAP-Challenge” (S105; NO), the destination judging unit 1053 advances the processing to S106. This is because the authentication method designated by the authentication request is judged to be the authentication method “PAP” carried out by the proxy server 200 if the authentication method is not CHAP.

The selected records 1050 after the processing in S102-S105 described above can be judged to be the records each containing the authentication result of “success (permission)” of the authentication conducted in response to the authentication request transferred from the proxy server 200. As described above, the proxy server 200 is, in the case of receiving from the home server 100 a response containing the result of “success” in response to the authentication request transferred to the home server 100, configured to cache the user information contained in this response. Accordingly, the cache memory 203 of the proxy server 200 having the source address in this record 1050 is stored with the delete target user information.

Hereafter, in S106, the destination judging unit 1053 acquires the source address 105c in the record 1050 as an address of the delete request destination (transmission target) proxy server 200.

Thereafter, the destination judging unit 1053 judges whether or not the logs have been read to the end (whether the processing throughout all the records is finished or not)(S107). At this time, if the processing throughout all the records 1050 is not yet finished (S107; NO), the processing returns to S101. Whereas if the processing throughout all the records 1050 is finished, the destination judging unit 1053 terminates the processing.

The address, acquired in S106, of the transmission target proxy server 200 is given as a delete request generation instruction together with the delete target user information to the delete request generation unit 106. The delete request generation unit 106, upon receiving the delete request generation instruction, starts generating the delete request.

It is noted, a scheme may be such that each time the address is acquired in S106, the generation instruction of the delete request containing this address is given to the delete request generation unit 106, and may also be such that the delete request generation unit 106 is given the generation instruction of the delete request containing one or more addresses acquired so far in the process in S106 when the destination judging unit 1053 terminates the processing.

With the configuration described above and by the procedure given above, the proxy server specifying unit 105 specifies (infers) one or more proxy servers 200, which cache the delete target user information, from the history information 1052 of the authentication process. This makes it possible to easily check which proxy server 200 in the plurality of proxy servers 200 is cached with the delete target user information. Further, the delete request can be sent to only the proxy server(s) 200 cached with the user information.

<Delete Request Transmission Target Proxy Server Determining Procedure Based on Queuing of Authentication Request Packet>

Next, in the case of deleting the user information from the cache memory, a procedure (a configuration of the proxy server specifying unit 105) of inferring (specifying) the proxy server 200 on the basis of queuing by which an authentication request packet given from the proxy server 200 is retained, will be explained as a second method of specifying the user information delete request transmission target proxy server.

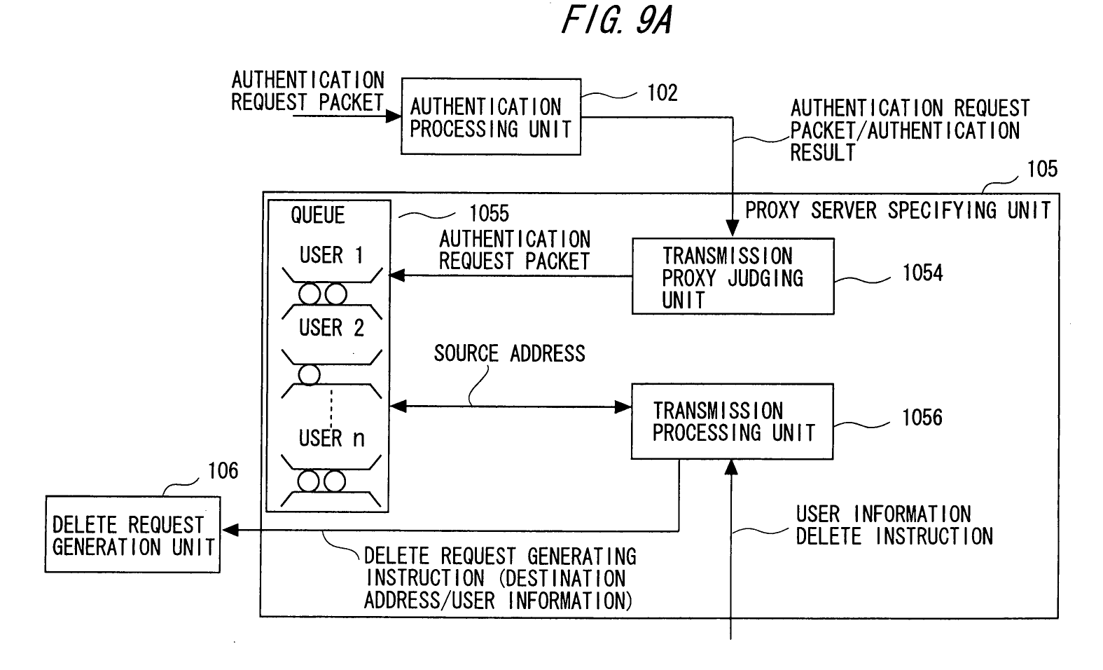

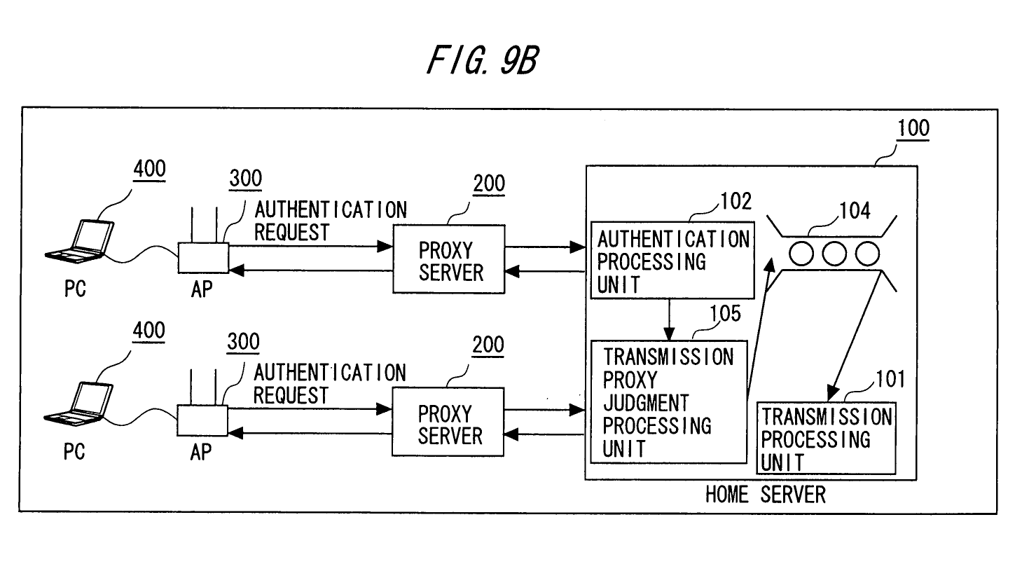

FIG. 9A is a diagram showing an example of a configuration, along the second method, of the proxy server specifying unit 105 shown in FIG. 1, and FIG. 9B is a schematic diagram showing one example of the user authentication system according to the second method.

As shown in FIG. 9A, the proxy server specifying unit 105 in the second method includes a transmission proxy judging unit 1054, a queue storage unit 1055 and a transmission processing unit 1056.

The transmission proxy judging unit 1054 receives, as pieces of information for inference, the authentication request packet from the authentication processing unit 102 and an authentication result to the authentication request thereof (e.g., the authentication request packet containing the authentication result). The transmission proxy judging unit 1054 stores a predetermined queue stored in the queue storage unit 1055 with the authentication request packet, among the authentication request packets received from the authentication processing unit 102, transferred from the proxy server 200, containing the user information formatted matching with the authentication method carried out by the proxy server 200 and showing “success (permission)” as a result of the authentication process. If the predetermined queue does not exist, a scheme can be made so that the queue is created afresh.

The queue storage unit 1055 has a plurality (n-pieces; n is a natural number) of queues prepared for every user. Each queue retains the authentication request packet associated with the user, which is stored by the transmission proxy judging unit 1054.

The transmission processing unit 1056 fetches the authentication request packet containing the delete target user information out of the queue of the queue storage unit 1055 in accordance with a user information delete instruction inputted from the operator, and gives the delete request generation unit 106 a source address of the fetched authentication request packet as a delete request destination address together with the delete target user information by way of a delete request generation instruction.

Note that the proxy server specifying unit 105 can take the following configuration in place of the configuration described above. The transmission proxy judging unit 1054 acquires the source address and the user information out of the authentication request packet, among the authentication request packets given from authentication processing unit 102, transferred from the proxy server 200, containing the user information formatted matching with the authentication method carried out by the proxy server 200 and showing “success (permission)” as a result of the authentication process. This source address and the user information are given as the delete request generation instruction to the delete request generation unit 106. The delete request generation unit 106 previously generates the user information delete request packet of which the source address is set as the destination, and queues the thus-generated packet in the user-associated queue of the queue storage unit 1055. Thereafter, the transmission processing unit 1056, when receiving the user information delete instruction, fetches the previously-queued delete request packet from the queue associated with the delete target user information, and transmits the fetched packet to each proxy server 200 via the communication unit 101 (FIG. 1).

FIG. 9B shows the home server 100, at least one proxy server 200, the APs 300 and the network-connectable terminals 400 utilized by the users.

In FIG. 9B, the home server receives the authentication request packet from the user. The home server 100 detects a host of the source from the source address stored in a header of the authentication request packet, and judges whether the source (sender) is the proxy server 200 or not. Through this processing, an access (the authentication request packet) from the AP 300 is excluded. Further, the home server 100 excludes an access (the authentication request packet) based on the CHAP method by referring to the RADIUS protocol attribute information. The proxy server 200 corresponding to the source of the selected authentication request packet can be thereby determined as a target cached with the user information. Then, this authentication request packet is queued. Thereafter, when the user information deleting/changing instruction is inputted, the delete request is sent to only the proxy server 200 corresponding to the source (sender) of the queued authentication request packet.

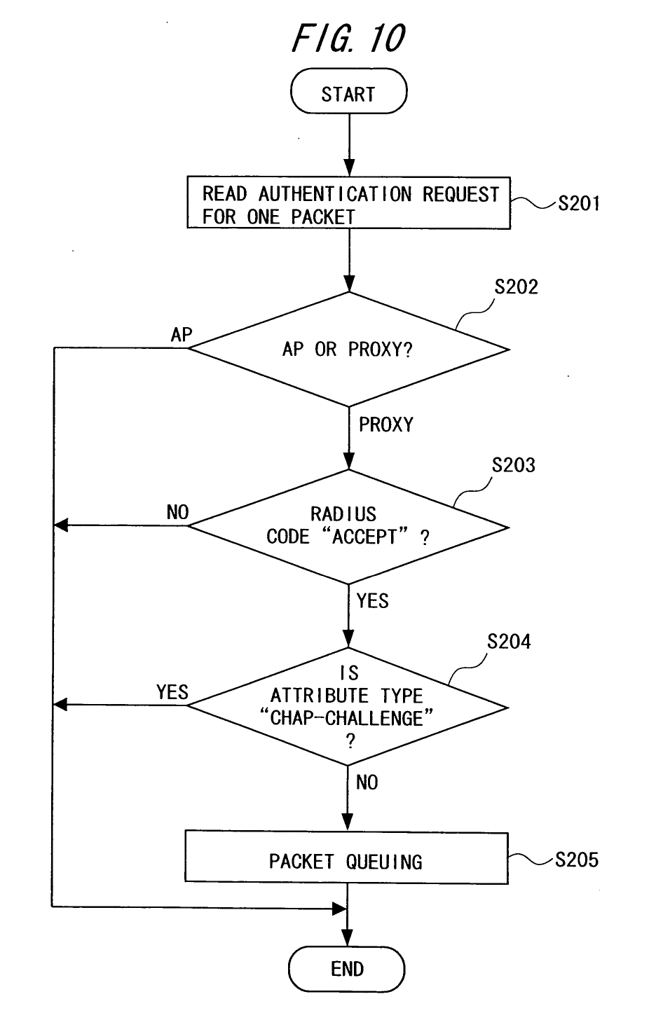

FIG. 10 is an explanatory flowchart of a delete request transmission target proxy server determination procedure (the processing by the transmission proxy judgment processing unit 1054 of the proxy server specifying unit 105 according to the second method) based on packet queuing.

A process shown in FIG. 10 is executed for every inference information (the authentication request packet and the authentication result thereof) inputted to the transmission proxy judgment processing unit 1054 from the authentication processing unit 102.

The transmission proxy judgment processing unit 1054, upon starting the process, reads one processing target authentication request packet (S201).

Next, the transmission proxy judgment processing unit 1054 judges whether the source (sender) of this authentication request packet is the proxy server 200 or the AP 300 (S202). This judging process is executed in a way that refers to the source address set in the header of the authentication request packet. The transmission proxy judgment processing unit 1054 previously knows the respective addresses of the proxy server 200 and the AP 300.

The transmission proxy judgment processing unit 1054, when judging in S202 that the source is the proxy server 200 (S202; Proxy), advances the processing to S203. By contrast with this, the transmission proxy judgment processing unit 1054, when judging that the source (sender) of the authentication request packet is the AP 300 (S202; AP), finishes the processing (comes to a standby status for a next authentication request packet).

Next, the transmission proxy judgment processing unit 1054 judges whether or not RADIUS Code of an authentication response packet containing a result of the authentication process is “accept” representing “success (permission)” for this authentication request packet (S203). At this time, if RADIUS Code of the authentication response packet is “accept” (S203; YES), the transmission proxy judgment processing unit 1054 advances the processing to S204. Whereas if RADIUS Code of the authentication response packet is not “accept” (S203; NO), the transmission proxy judgment processing unit 1054 terminates the processing.

In S204, the transmission proxy judgment processing unit 1054 judges whether or not Attribute type as one item of the RADIUS attribute information of the authentication request packet is “CHAP-Challenge”. In other words, it is judged whether the authentication method is CHAP or not. The process in S204 is, as explained in the first method, conducted in a way that judges whether or not a value of Attribute type is “60” representing “CHAP-Challenge”. At this time, the transmission proxy judgment processing unit 1054, if the authentication method is CHAP (S204; YES), as CHAP is not the authentication method carried out by the proxy server 200, returns the processing to S201. Whereas if the authentication method is not CHAP (S204; NO), the authentication method can be presumed to be PAP carried out by the proxy server 200, and therefore the transmission proxy judgment processing unit 1054 queues (stores) the authentication request packet in the queue (associated with the user specified by the user information contained in the authentication request packet) of the queue storage unit 1055 (S205). Then, the processing comes to an end.

According to the second method explained above, the same operational effects as those of the first method can be obtained. The second method is, however, capable of specifying (inferring), when deleting/changing the user information, the delete request transmission target proxy server 200 by acquiring the source address of the authentication request packet queued in the queue. Accordingly, the process on such an occasion that the user information deleting/changing instruction is inputted, becomes easier and higher in speed than by the first method.

<Delete Processing Procedure of User Information with User ID Designated>

Next, a method of deleting the user information stored on the cache memory 203 of the proxy server 200 in a way that designates a user ID from on the side of the homer server 100, will be explained.

In the mode illustrated in FIG. 3, the RADIUS-based authentication request packet is sent as the delete request to the proxy server 200 from the home server 100. As discussed above, this authentication request packet (the authentication request message) contains an entry area (field) for designating the user information. Normally, the user name and the password are entered as the user information in the form of “User Name (User ID)/Authentication Password” in this field.

By contrast, in the authentication request packet as the delete request, a special character string (the character string (specific example: “Cache clear”) that does not contain, e.g., “/(slush)” so as not to be regarded as a normal user ID) distinguishable from the general user ID representing that the user information is the cache-clear-only user information, is set in a user name storage field (user name area) in the storage area for the user information. Moreover, a user ID associated with the delete target user information is set in an authentication password storage field (password area). Namely, the user information dedicated to cache-clear for designating the specified delete target user information is expressed in the form of “Cache_clear/user ID”.

(The RADIUS server 210 of) The proxy server 200 can know that the authentication request is the delete request and also know the delete target user information by receiving the authentication request packet containing the cache-clear-only user information as described above from the home server 100.

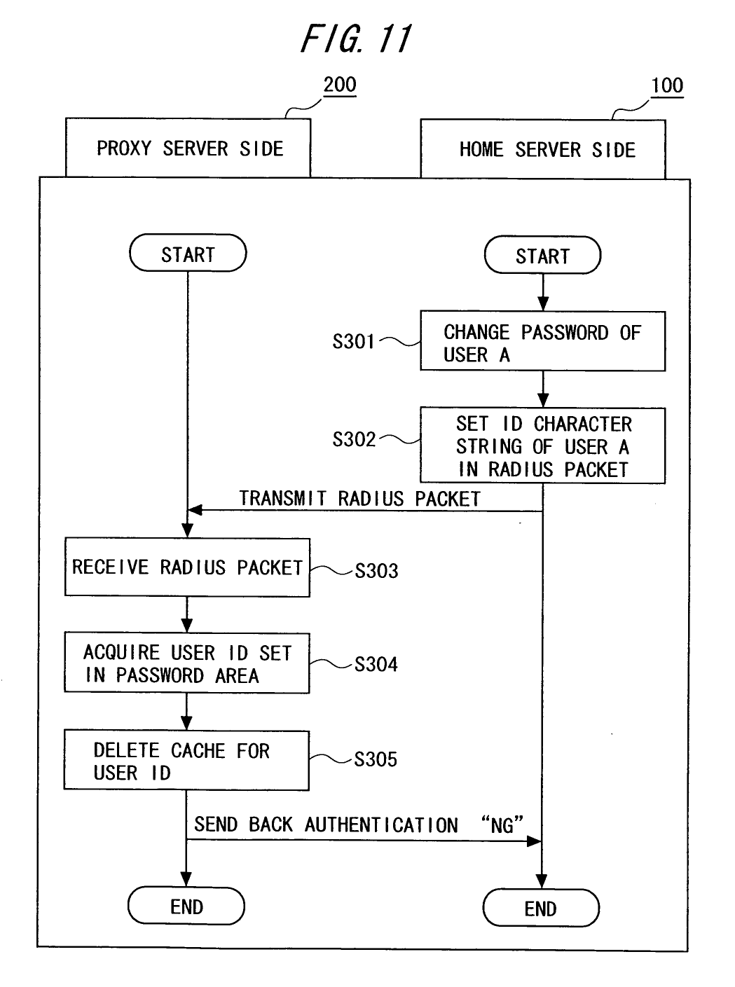

FIG. 11 is an explanatory flowchart of the delete processing procedure of the user information with the user ID designated.

To begin with, in the home server 100, if an authentication password of a user A is changed due to a factor such as responding to a request from the user A, through the operation of the home server 100, the update unit 102B changes the authentication password of the user A on the database 102A (S301).

In this case, the delete request generation unit 106 (CGI 111) of the home server 100 sets the cache-clear-only user information in which the user ID of the user A is set in the password area, is set in the authentication request packet (RADIUS packet) (S302). Then, the home server 100 transmits this authentication request packet (delete request) to the proxy server 200.

(The RADIUS server 210 of) The proxy server 200 receives the authentication request packet transmitted from the home server 100 (S303). The proxy server 200 acquires the delete target user ID from the password area of this authentication request packet (S304). Then, the proxy server 200 deletes the user information containing the acquired user ID from the cache memory 203 (S305).

After deleting the cache stored with the user information containing the user ID concerned, the proxy server 200 sends non-permission (NG) of the authentication back to the home server 100. The home server 100 can deal with a response of the non-permission of authentication as notification of completion of the user information delete process.

Note that the execution of the cache-clear process of the specified user information is triggered by changing the user information on the database 102A in the example shown in FIG. 11, however, the present invention is not limited to this trigger timing. Namely, the cache-clear process of the specified user information may be so executed as to be triggered by a predetermined proper timing in a way that aims at only cache-clear.

<Procedure of Cache-Clear Process of User Information for All Users>

Next, a process of deleting all the user information cached (stored on the cache memory 203) by the proxy server 200 from the home server 100, will be explained.

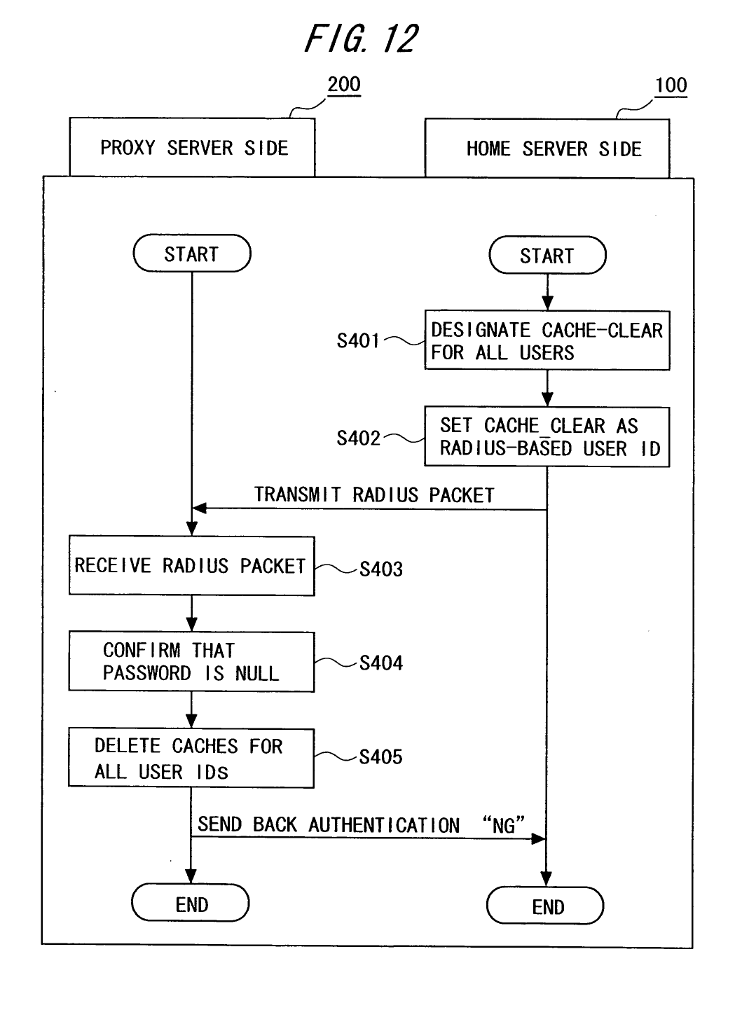

FIG. 12 is an explanatory flowchart of the process of deleting the caches stored with the user information associated with all the users on the side of the proxy server from the home server.

To start with, (the delete request generation unit 106 (CGI 111) of) the home server 100, when accepting an instruction of cache-clear of all the users (S401), sets the cache-clear-only user information, which designates the deletion about all the user IDs cached by the proxy server 200, in the authentication request packet (S402). The cache-clear-only user information, for example, can be organized as the user information, wherein the special character string (e.g., “Cache_clear”) representing the aforementioned cache-clear-only user information is set in the user name area, and the password is set null. A variety of formats can be, if distinguishable from the normal user information, applied as the format of the cache-clear-only user information. Then, the home server 100 transmits this authentication request packet (RADIUS packet) to the proxy server 200. At this time, the authentication request packet is transmitted to all the proxy servers 200 as target servers that are cached with the user information at this point of time.

Each proxy server 200 receives the authentication request packet transmitted from the home server 100 (S403). The proxy server 200 recognizes from the user ID's being “Cache_clear” that this authentication request packet is the delete request, and confirms that the password area is null (S404). This enables the proxy server 200 to recognize that the delete target information about this delete request is all the user information stored on the cache memory 203 by confirming that the password area is null. Then, the proxy server 200 deletes the caches (all the user information stored on the cache memory 203) cached with the user information associated with all the users in response to the delete request of the acquired authentication request packet (S405).

Thereafter, each proxy server 200 sends the non-permission (NG) of authentication back to the home server 100. The home server 100 can deal with a response of the non-permission of authentication as notification of completion of cache-clear.

In the operation shown in FIG. 12, the home server 100 executes the process of specifying the proxy server 200 cached with the user information in the plurality of proxy servers 200. Both of the first method and the second method described above can be applied to this process. When the first method is applied, a routine with omission of the process in S102 among the processes shown in FIG. 6 is executed, whereby the proxy server 200 cached with the user information can be inferred as the destination of the delete request. By contrast, when the second method is applied, the source addresses of the authentication request packets queued in all the queues are handled as the addresses of the proxy servers 200 serving as the destinations of the delete request.

The user authentication system performs the operation shown in FIG. 12, thereby making it possible to delete all the cached user information simultaneously from all the proxy servers 200 cached with the user information only by the operation of the home server 100 when the home server gets into a fault or gets subjected to maintenance.

### Effects of Embodiment

According to the embodiment of the present invention discussed so far, the inference of all the proxy servers 200 cached with the delete target specified user information is triggered by changing or deleting the user information stored on the database 102a of the home server 100 or triggered by the predetermined proper timing, and the user information delete request can be transferred simultaneously to the respective inferred proxy servers 200. Then, each proxy server 200 deletes the delete target specified user information from the cache memory 203 in response to the delete request.

This prevents the access to the network from being permitted by the change/delete-related user information left on the cache memory of the proxy server 200 after updating the user information (changing/deleting the user information) in the home server 100.

Further, the delete request is transmitted simultaneously to all the transmission target proxy servers 200 from the home server 100, whereby the delete process is executed. Owing to this operation, the user information may not be deleted from the cache memory by operating individually the proxy server 200 as by the conventional method. Therefore, an occurrence of a time-lag caused till the delete target user information is deleted from all the proxy servers 200, can be restrained. Accordingly, it is feasible to eliminate a possibility that the network access might be permitted by the user information left in the proxy server 200 due to this time-lag.

Moreover, the individual operation of the proxy server 200 can be avoided, and hence the delete process of the cached user information can be smoothly easily executed.

Furthermore, it is possible to delete simultaneously all the cached user information from all the proxy servers 200 as the delete target servers having the cached user information.

### MODIFIED EXAMPLE

It should be noted that the user authentication system of the present invention is not limited to only the present embodiment and can be, as a matter of course, changed in a variety of forms within the range that does not deviate from the gist of the present invention.

For instance, in the present embodiment, in the case of the first method and the second method for determining the proxy server to which the delete request is sent, it is considered that the already-become-the-target proxy server might be determined dually by the respective methods. In such a case, the overlapped proxy server may be excluded before or after determining the transmission of the delete request by referring to the user ID or the IP address.

### INDUSTRIAL APPLICABILITY

The present invention can be applied to an industry where the user authentication process for the network connection is conducted.

1. A user authentication system comprising:
a first server executing a user authentication process and a transmission process of an authentication result when receiving a request for authenticating a user's access to a network; and
at least one second server existing between the user and said first server, having a storage unit, executing the authentication process and notifying the user of the authentication result thereof as a substitute for said first server by use of, if said storage unit is stored with user information for authenticating the user when receiving the authentication request from the user, this user information, transferring the authentication request to said first server if said storage unit is not stored with the user information concerned, receiving from said first server the authentication result about the authentication request and notifying the user of this authentication result, and storing said storage unit with the user information of the user concerned that is contained in the authentication result if the notified authentication result indicates a success of authentication at this time,
said first server including:
a unit transmitting a user information delete request to said second server of which said storage unit is stored with the user information,
at least said one second server including:
a unit deleting the user information specified by this delete request from said storage unit when receiving the delete request from said first server.

2. A user authentication system according to claim 1, wherein said first server further includes:
a unit inferring, when receiving an instruction of deleting specified user information, said second server of which said storage unit is stored with this specified user information; and
a unit generating a delete request of the specified user information that is sent to said inferred second server.

3. A user authentication system according to claim 1, wherein said first server further includes:
a unit retaining history information of the authentication process with respect to the user; and
a unit inferring said second server stored with the delete target user information from the history information.

4. A user authentication system according to claim 1, wherein said first server further includes:
a unit storing a storage unit with the authentication request received from said second server; and
a unit inferring said second server stored with the delete target user information from the authentication request stored on said storage unit.

5. A user authentication system according to claims 1, wherein said first server further includes:
a unit inferring all of said second servers of which said storage unit are stored with the user information when receiving an instruction of deleting all the user information; and
a unit generating a delete request to be sent to said inferred second servers, for deleting all the user information stored on said storage unit.

6. A user authentication system according to claim 1, wherein said second server includes:
a Web server receiving a HTTP message being sent from said first server and containing the delete request; and
a CGI started up by said Web server and executing a process of deleting the user information designated by the delete request from said storage unit.

7. A user authentication system according to claims 1, wherein each of said first server and said second server receives a RADIUS-based authentication request packet and executes the authentication process,
said first server transmits the authentication request packet containing the user information delete request to said second server of which said storage unit is stored with the delete target user information, and
said second server deletes the user information designated by this delete request from said storage unit if the received authentication request packet contains the user information delete request.

8. A first server executing a user authentication process and a process of transmitting an authentication result when receiving a request for authenticating a user's access to a network, said first server comprising:
a unit sending a user information delete request to a second server of which storage unit is stored with user information.

9. A first server according to claim 8, further comprising:
a unit inferring, when receiving an instruction of deleting specified user information, said second server of which said storage unit is stored with this specified user information; and
a unit generating a delete request of the specified user information that is sent to said inferred second server.

10. A first server according to claim 8, further comprising:
a unit retaining history information of the authentication process with respect to the user; and
a unit inferring, from the history information, said second server stored with delete target user information.

11. A first server according to claim 8, further comprising:
a unit storing a storage unit with the authentication request received from said second server; and
a unit inferring, from the authentication request stored on said storage unit, said second server stored with the delete target user information.

12. A first server according to claims 8, further comprising:
a unit inferring, when receiving an instruction of deleting all the user information, all of said second servers of which said storage unit are stored with the user information; and
a unit generating a delete request, to be sent to said inferred second servers, for deleting all the user information stored on said storage unit.

13. A first server according to claims 8, wherein each of said first server and said second server receives a RADIUS-based authentication request packet and executes the authentication process, and
said first server transmits the authentication request packet containing the user information delete request to said second server of which said storage unit is stored with the delete target user information.

14. A second server existing between a user and a first server, having a storage unit, executing the authentication process and notifying the user of the authentication result thereof as a substitute for said first server by use of, if said storage unit is stored with user information for authenticating the user when receiving the authentication request from the user, this user information, transferring the authentication request to said first server if said storage unit is not stored with the user information concerned, receiving from said first server the authentication result about the authentication request and notifying the user of this authentication result, and storing said storage unit with the user information of the user concerned that is contained in the authentication result if the notified authentication result indicates a success of authentication at this time,
said second server comprising:
a unit deleting the user information specified by this delete request from said storage unit when receiving the delete request from said first server.

15. A second server according to claim 14, further comprising:
a Web server receiving a HTTP message sent from said first server and containing the delete request; and
a CGI started up by said Web server and executing a process of deleting the user information designated by the delete request from said storage unit.

16. A second server according to claim 14, wherein each of said first server and said second server receives a RADIUS-based authentication request packet and executes the authentication process, and
said second server deletes the user information designated by this delete request from said storage unit if the received authentication request packet contains the user information delete request.
